(19) United States
(12) Patent Application Publication
(10) Pub. No.: US 2023/0004766 A1
(43) Pub. Date: Jan. 5, 2023

(54) PRINTING SUPPORT DEVICE, PRINTING SUPPORT METHOD AND NON-TRANSITORY COMPUTER-READABLE RECORDING MEDIUM ENCODED WITH PRINTING SUPPORT PROGRAM

(71) Applicant: Konica Minolta, Inc., Tokyo (JP)

(72) Inventor: Masanori NISHIDA, Kobe-shi (JP)

(73) Assignee: Konica Minolta, Inc., Tokyo (JP)

(21) Appl. No.: 17/839,690

(22) Filed: Jun. 14, 2022

(30) Foreign Application Priority Data
Jun. 30, 2021 (JP) 2021-109349

(51) Int. Cl. G06K 15/02; G06F 3/12

(52) U.S. Cl. CPC G06K 15/1805; G06K 15/1809; G06F 3/1205; G06F 3/1254

(57) ABSTRACT

A printing support device that supports a printing process of causing an image processing apparatus to execute a print job includes a hardware processor, and the hardware processor detects a print start instruction, performs setting such that the print job is accumulated without being executed by the image forming apparatus in response to detection of the start instruction, acquires job information in regard to the print job accumulated in the image forming apparatus, determines a printing condition based on the job information, performing setting such that the print job is executed by the image forming apparatus in accordance with the determined printing condition after the printing condition is determined and instructs the application to output the print job.

The entire disclosure of Japanese patent Application No. 2021-109349 filed on Jun. 30, 2021, is incorporated herein by reference in its entirety.

### BACKGROUND

### Technological Field

The present invention relates to a printing support device, a printing support method and a non-transitory computer readable recording medium encoded with a printing support program. In particular, the present invention relates to a printing support device that supports a printing process of causing an image forming apparatus to execute a print job output by an application, a printing support method performed in the printing support device and a non-transitory computer readable recording medium encoded with a printing support program for causing a computer to perform the printing support method.

### Description of the Related Art

In recent years, in regard to data printing work in workplaces, print settings are complicated due to various applications for creating data subject to printing, different printing conditions depending on the purpose of use of a printed matter even for one data piece, and the like, and misprinting often occurs. Japanese Patent Laid-Open No. 2002-254773 describes an image forming apparatus characterized by having a total page count acquiring portion that acquires the total number of pages of a document subject to image formation and an image formation setting portion that changes a setting for image formation in accordance with the total page count acquired by the acquiring portion. However, the technique described in Japanese Patent Laid-Open No. 2002-254773 requires installation of such an image forming apparatus and cannot be implemented by a computer in which an application is executed.

On the other hand, RPA (Robotic Process Automation) systems are being introduced into routine work in order to improve work efficiency. With the introduction of the RPA system, printing can be performed using an existing computer and an existing image forming apparatus with a print setting corresponding to a standard application and the purpose of use. This can prevent an occurrence of misprinting. However, with the PRA system, it is necessary to develop a program for each application and each purpose of use, so that there is a problem that introduction of the system is complicated.

### SUMMARY

According to one aspect of the present invention, a printing support device that supports a printing process of causing an image processing apparatus to execute a print job includes a hardware processor, and the hardware processor detects a print start instruction, performs setting such that the print job is accumulated without being executed by the image forming apparatus in response to detection of the start instruction, acquires job information in regard to the print job accumulated in the image forming apparatus, determines a printing condition based on the job information, performs setting such that the print job is executed by the image forming apparatus in accordance with the determined printing condition after the printing condition is determined, and instructs the application to output the print job.

According to another aspect of the present invention, a printing support method that is performed in a printing support device that executes a printing process of causing an image processing apparatus to execute a print job, includes an instruction detecting step of detecting a print start instruction, an accumulation setting step of performing setting such that the print job is accumulated without being executed by the image forming apparatus in response to detection of the start instruction, a job information acquiring step of acquiring job information in regard to the print job accumulated in the image forming apparatus, a printing condition determining step of determining a printing condition based on the job information, a setting step of performing setting such that the print job is executed by the image forming apparatus in accordance with the determined printing condition after the printing condition is determined, and an output instructing step of instructing the application to output the print job.

According to yet another aspect of the present invention, a non-transitory computer-readable recording medium is encoded with a printing support program executed in a computer that executes a printing process of causing an image processing apparatus to execute a print job, causes the computer to perform an instruction detecting step of detecting a print start instruction, an accumulation setting step of performing setting such that the print job is accumulated without being executed by the image forming apparatus in response to detection of the start instruction, a job information acquiring step of acquiring job information in regard to the print job accumulated in the image forming apparatus, a printing condition determining step of determining a printing condition based on the job information, a setting step of performing setting such that the print job is executed by the image forming apparatus in accordance with the determined printing condition after the printing condition is determined, and an output instructing step of instructing the application to output the print job.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an overview of a printing system in one embodiment of the present invention;

FIG. 2 is a block diagram showing one example of the outline of the hardware configuration of a PC in the present embodiment;

FIG. 3 is a block diagram showing the outline of the hardware configuration of an MFP in the present embodiment;

FIG. 4 is a block diagram showing one example of functions of a CPU included in the PC in the present embodiment;

FIG. 5 is a diagram showing one example of the format of job information;

FIG. 6 is a first flowchart showing one example of a flow of a process for each of a user, an application portion, a support portion, a printer driver portion and the MFP; and

FIG. 7 is a second flowchart showing one example of the flow of the process for each of the user, the application portion, the support portion, the printer driver portion and the MFP.

### DETAILED DESCRIPTION OF EMBODIMENTS

Hereinafter, one or more embodiments of the present invention will be described with reference to the drawings. However, the scope of the invention is not limited to the disclosed embodiments.

Embodiments of the present invention will be described below with reference to the drawings. In the following description, the same parts are denoted with the same reference characters. Their names and functions are also the same. Thus, a detailed description thereof will not be repeated.

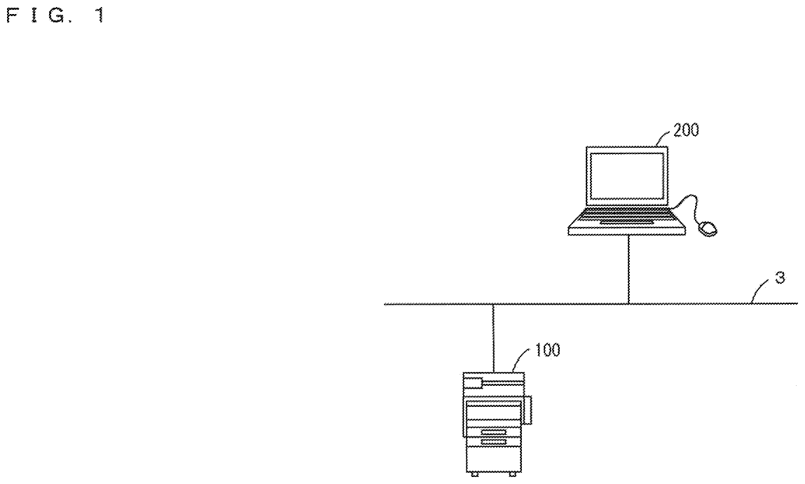

FIG. 1 is a diagram showing one example of the overview of a printing system in one embodiment of the present embodiment. Referring to FIG. 1, the printing system 1 includes an MFP (Multi Function Peripheral) 100 and a personal computer (hereinafter referred to as “PC”) 200. The PC 200 is one example of a printing support device and is a general computer. The MFP 100 is one example of an image forming apparatus. The MFP 100 and the PC 200 are respectively connected to a network 3. Therefore, the MFP 100 and the PC 200 can communicate with each other.

The network 3 is a local area network (LAN). The network 3 is not limited to a LAN, and may be a WAN (Wide Area Network) or the Internet.

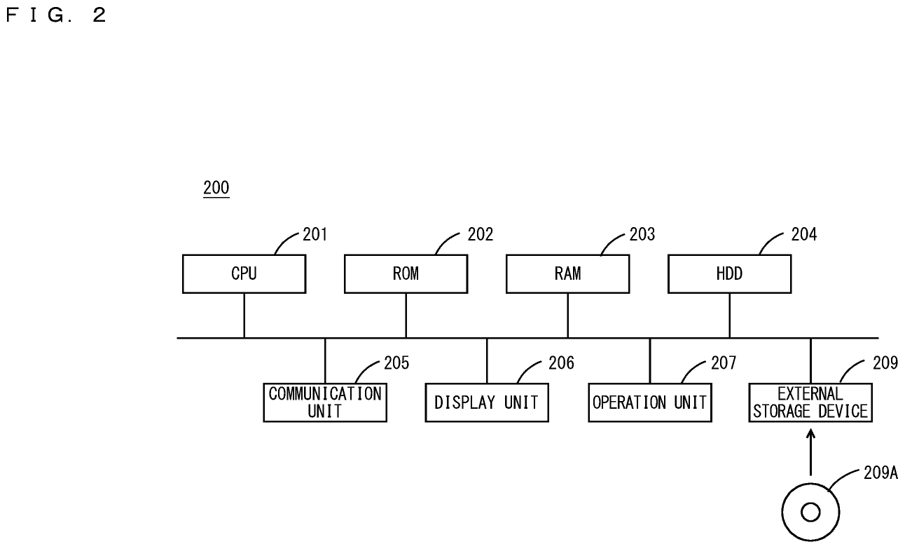

FIG. 2 is a block diagram showing one example of the outline of the hardware configuration of the PC in the present embodiment. Referring to FIG. 2, the PC 200 includes a CPU 201 for controlling the PC 200 as a whole, a ROM 202 for storing a program to be executed by the CPU 201, a RAM 203 that is used as a work area for the CPU 201, a HDD 204 for storing data in a non-volatile manner, a communication unit 205 that connects the CPU 201 to the network 3, a display unit 206 that displays information, an operation unit 207 that receives input by a user's operation and an external storage device 209.

The display unit 206 is, but not limited to, a liquid crystal display device. Instead of a liquid crystal display device, an organic electroluminescence (EL) display may be used.

The external storage device 209 is mounted with a CD-ROM (Compact Disk Read Only Memory) 209A. While executing a program stored in the ROM 202 by way of example in the present embodiment, the CPU 201 may control the external storage device 209, read out a program to be executed by the CPU 201 from the CD-ROM 209A and store the read program in the RAM 203 for execution.

A recording medium for storing a program to be executed by the CPU 201 is not limited to the CD-ROM 209A but may be a flexible disc, a cassette tape, an optical disc (MO (Magnetic Optical Disc)/MD (Mini Disc)/DVD (Digital Versatile Disc)), an IC card, an optical card, or a semiconductor memory such as a mask ROM or an EPROM (Erasable Programmable ROM). Further, the CPU 201 loads a program stored in the HDD 204 into the RAM 203 for execution in the CPU 201. The program stored in the HDD 204 includes a program downloaded by the CPU 201 from a computer connected to the Internet or a program written in the HDD 204 by a computer connected to the Internet. The program referred to here includes not only a program directly executable by the CPU 201 but also a source program, a compressed program, an encrypted program and the like.

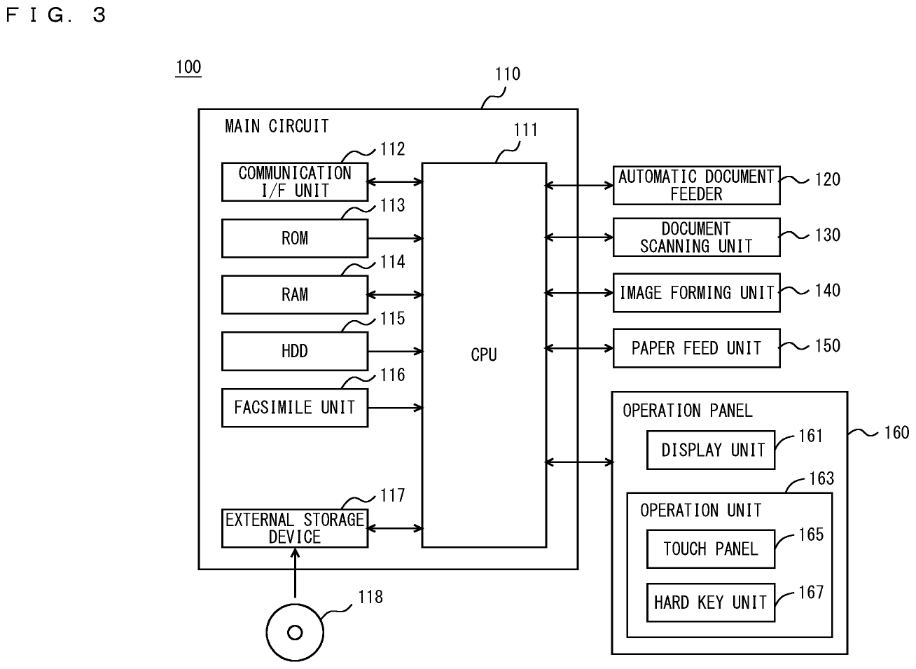

FIG. 3 is a block diagram showing the outline of the hardware configuration of the MFP in the present embodiment. Referring to FIG. 3, the MFP 100 that functions as an image forming apparatus includes a main circuit 110, a document scanning unit 130 for scanning a document, an automatic document feeder 120 for conveying a document to the document scanning unit 130, an image forming unit 140 for forming an image on a paper (a sheet of paper) or other medium based on image data output by the document scanning unit 130 that has scanned a document, a paper feed unit 150 for supplying a paper to the image forming unit 140, and an operation panel 160 serving as a user interface.

The automatic document feeder 120 automatically conveys a plurality of documents set on a document tray to a predetermined document scanning position set on a platen glass of the document scanning unit 130 one by one, and discharges a document having an image formed thereon and scanned by the document scanning unit 130 onto a document discharge tray. The document scanning unit 130 includes a light source that emits light to a document conveyed to the document scanning position and an optoelectronic transducer that receives light reflected from the document, and scans a document image corresponding to the size of the document. The optoelectronic transducer converts the received light into image data, which is an electrical signal, to output the image data to the image forming unit 140. The paper feed unit 150 conveys papers stored in a paper feed tray to the image forming unit 140.

The image forming unit 140 forms an image by a well-known electrophotographic method, and forms an image on a paper conveyed by the paper feed unit 150 based on processed image data or image data that is externally received to discharge the paper on which the image is formed to the paper discharge tray. The data process includes various data processes such as shading correction performed on the image data received from the document scanning unit 130. The image forming unit 140 includes a paper reversing path and can form images on both sides of a paper. The paper reversing path is a path that reverses the front and back of a paper on which an image is formed on one side (front side) in the image forming unit 140 and guides the paper to the image forming unit 140. Thus, the image forming unit 140 forms an image on the other side (back side) of the paper supplied from the paper reversing path.

The main circuit 110 includes a CPU 111 that controls the MFP 100 as a whole, a communication interface (I/F) unit 112, a ROM 113, a RAM 114, a hard disc drive (HDD) 115 as a mass storage, a facsimile unit 116 and an external storage device 117. The CPU 111 is connected to the automatic document feeder 120, the document scanning unit 130, the image forming unit 140, the paper feed unit 150 and the operation panel 160, and controls the MFP 100 as a whole.

The facsimile unit 116 is connected to the Public Switched Telephone Network (PSTN), transmits facsimile data to the PSTN or receives facsimile data from the PSTN. The facsimile unit 116 stores the received facsimile data in the HDD 115, converts the facsimile data into print data that is printable in the image forming unit 140 and outputs the data to the image forming unit 140. Thus, the image forming unit 140 forms an image represented by the facsimile data received from the facsimile unit 116 on a paper. Further, the facsimile unit 116 converts the data stored in the HDD 115 into facsimile data and transmits the converted facsimile data to a facsimile machine connected to the PSTN.

The communication I/F unit 112 is an interface for connecting the MFP 100 to the network 3. The communication I/F unit 112 communicates with the PC 200 connected to the network 3 using a communication protocol such as a TCP (Transmission Control Protocol) or an FTP (File Transfer Protocol).

The ROM 113 stores a program executed by the CPU 111 or data required to execute the program. The RAM 114 is used as a work area when the CPU 111 executes a program. Further, the RAM 114 temporarily stores scan images successively sent from the document scanning unit 130.

The operation panel 160 is provided on an upper surface of the MFP 100. The operation panel 160 includes a display unit 161 and an operation unit 163. The display unit 161 is a Liquid Crystal Display (LCD) device, for example, and displays an instruction menu for a user, information about acquired image data, etc. As long as displaying images, an organic EL display may be used instead of an LCD, for example.

The operation unit 163 includes a touch panel 165 and a hard key unit 167. The touch panel 165 is a capacitance type. The touch panel 165 is not limited to the capacitance type, and another type such as a resistive film type, a surface acoustic wave type, an infrared type and an electromagnetic induction type can be used. The hard key unit 167 includes a plurality of hard keys. The hard keys are contact switches, for example.

The CPU 111 executes a print job. In a case in which executing a print job, the CPU 111 generates image data, outputs the image data to the image forming unit 140 and causes the image forming unit 140 to form an image on a paper. The image data is raster data, for example. A print job includes data subject to printing and a printing condition. Data subject to printing may be data in a bitmap format or application data. Data subject to printing includes data for each of one or more pages. The printing condition include an accumulation condition, an aggregation condition and a formation side condition. The accumulation condition is a condition defining whether to accumulate a print job without execution or to execute a print job without accumulation. The aggregation condition is a condition defining the number of pages to be formed on one paper in image formation. The formation side condition is a condition defining whether images are to be formed on both of the front and back sides of a paper or only on one side of the paper. The CPU 111 generates image data from data that is included in a print job and is subject to printing in accordance with a printing condition included in the print job and outputs the image data to the image forming unit 140.

In a case in which the communication I/F unit 112 receives a print job from the PC 200, the CPU 111 determines whether an accumulation condition is set in a printing condition included in the print job. In a case in which an accumulation condition indicating that a print job is to be accumulated without being executed is set in a printing condition, the CPU 111 stores a print job in the HDD 115 without execution. In a case in which an accumulation condition indicating that a print job is to be executed without being accumulated is set in a printing condition, the CPU 111 executes a print job without accumulating the print job in the HDD 115.

The external storage device 117 is controlled by the CPU 111 and is mounted with the CD-ROM 118. While the CPU 111 executes a program stored in the ROM 113 by way of example in the present embodiment, the CPU 111 may control the external storage device 117, read out a program to be executed by the CPU 111 from the CD-ROM 118 and store the read program in the RAM 102 for execution.

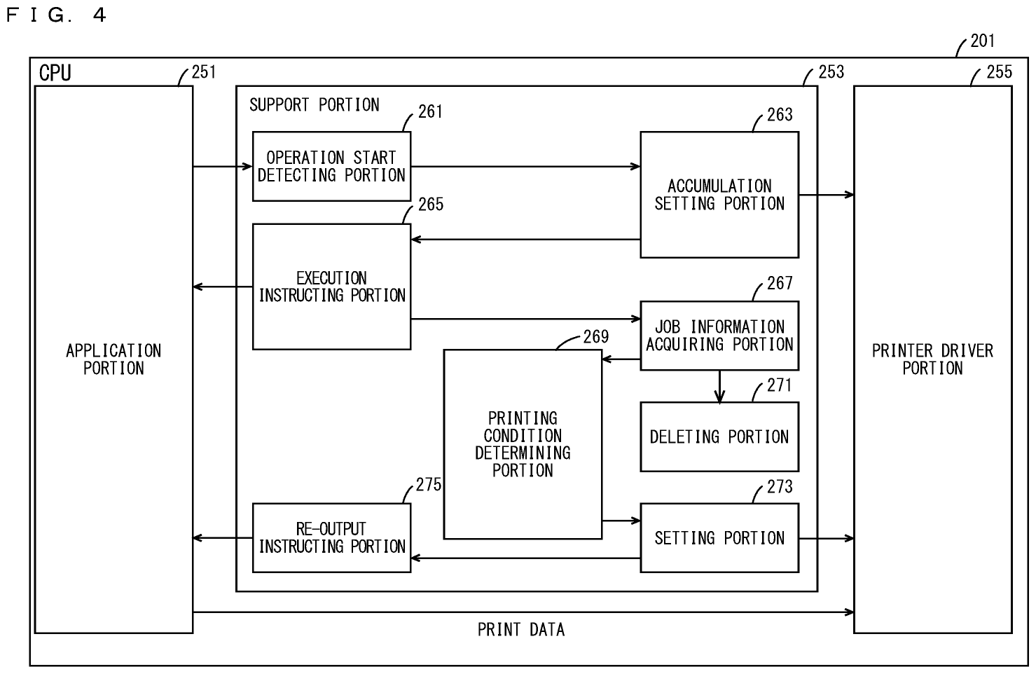

FIG. 4 is a block diagram showing one example of functions of a CPU included in the PC in the present embodiment. The functions shown in FIG. 4 may be implemented in hardware, or may be implemented by execution of a printing support program, an application program and a printer driver program stored in the ROM 202, the HDD 204 or the CD-ROM 209A by the CPU 201 included in the PC 200.

Referring to FIG. 4, the CPU 201 included in the PC 200 includes an application portion 251, a support portion 253 and a printer driver portion 255. The application portion 251 is a function implemented by the CPU 201 when the CPU 201 executes an application program. The same number of application portions 251 as the number of application programs executed by the CPU 201 are implemented in the CPU 201. Application programs include a document editing program, a spreadsheet program, a drawing program, an image editing program and a database creation program, for example. The application portion 251, the support portion 253 and the printer driver portion 255 are arranged on an operating system implemented in the CPU 111.

The printer driver portion 255 is a function implemented by the CPU 201 when the CPU 201 executes the printer driver program. Here, the printer driver portion 255 is implemented when the CPU 201 executes the printer driver program for controlling the MFP 100. The same number of printer driver portions 255 as the number of image forming apparatuses to be controlled by the PC 200 are implemented in the CPU 201.

The support portion 253 is a function implemented by the CPU 201 when the CPU 201 executes the printing support program. The printing support program is a program developed to realize RPA. Therefore, the support portion 253 is a function that is part of an RPA system. The support portion 253 includes an operation start detecting portion 261, an accumulation setting portion 263, an execution instructing portion 265, a job information acquiring portion 267, a printing condition determining portion 269, a deleting portion 271, a setting portion 273 and a re-output instructing portion 275.

The operation start detecting portion 261 detects a print start instruction input to the application portion 251 by a user operating the PC 200. For example, the operation start detecting portion 261 monitors a predetermined portion of the operating system to detect an operation for starting printing that is input to the application portion 251 as a start instruction. Further, the application portion 251 analyzes an image displayed in the display unit 206, so that the operation start detecting portion 261 detects an operation for starting printing that is input to the application portion 251 as a start instruction. For example, the operation start detecting portion 261 recognizes characters in an image displayed in the display unit 206 by the application portion 251, determines an area having characters subject for printing and detects a print start instruction in a case which a cursor moves to the area. Further, in a case in which the application portion 251 displays a printing condition setting screen for setting a printing condition in the display unit 206, the operation start detecting portion 261 recognizes characters in an image in the printing condition setting screen displayed in the display unit 206 and detects a print start instruction when characters representing a printing condition is included in the recognized characters.

The accumulation setting portion 263 performs setting such a print job is to be accumulated without being executed by an image forming apparatus in response to detection of a print start instruction by the operation start detecting portion 261. The accumulation setting portion 263 determines an image forming apparatus to which a print job is output from the application portion 251. An image forming apparatus to which a print job is output from the application portion 251 may be set in a default setting or may be designated by a user. The accumulation setting portion 263 determines an image forming apparatus set in the default setting by inquiring the operating system. Further, the application portion 251 analyzes an image displayed in the display unit 206, so that the accumulation setting portion 263 determines an image forming apparatus designated by the user. For example, in a case in which the application portion 251 displays a device designation screen for designating an image forming apparatus or a printing condition setting screen in the display unit 206, the accumulation setting portion 263 recognizes characters in an image displayed in the display unit 206, extracts device identification information for identifying an image forming apparatus, and determines the image forming apparatus specified by the extracted device identification information as an image forming apparatus designated by the user. Here, the accumulation setting portion 263 determines that the MFP 100 is designated as an image forming apparatus by the user, by way of example.

The accumulation setting portion 263 provides an instruction to the printer driver portion 255 controlling the MFP 100 such that a print job is accumulated without being executed by the MFP 100. For example, the accumulation setting portion 263 outputs an accumulation command for making a setting that causes a print job to be accumulated without being executed by MFP 100 to the printer driver portion 255. An accumulation command includes device identification information for identifying the MFP 100.

In response to receiving an accumulation command from the accumulation setting portion 263, the printer driver portion 255 changes the print setting of a print job to be subsequently received from the application portion 251 such that the print job is accumulated without being executed, and makes a setting that causes the changed print job to be transmitted to the MFP 100. The printer driver portion 255 may control the MFP 100 and may set the MFP 100 such that a print job is accumulated without being executed.

A print job will now be described. A print job is transmitted from the printer driver portion 255 to the MFP 100. A print job includes print data generated from application data, and job information. Job information includes a printing condition representing a condition for printing. Print data may be application data. A print job may be output from the application portion 251 to the printer driver portion 255. In this case, the printer driver portion 255 changes part of a print job output from the application portion 251 to transmit the print job to the MFP 100.

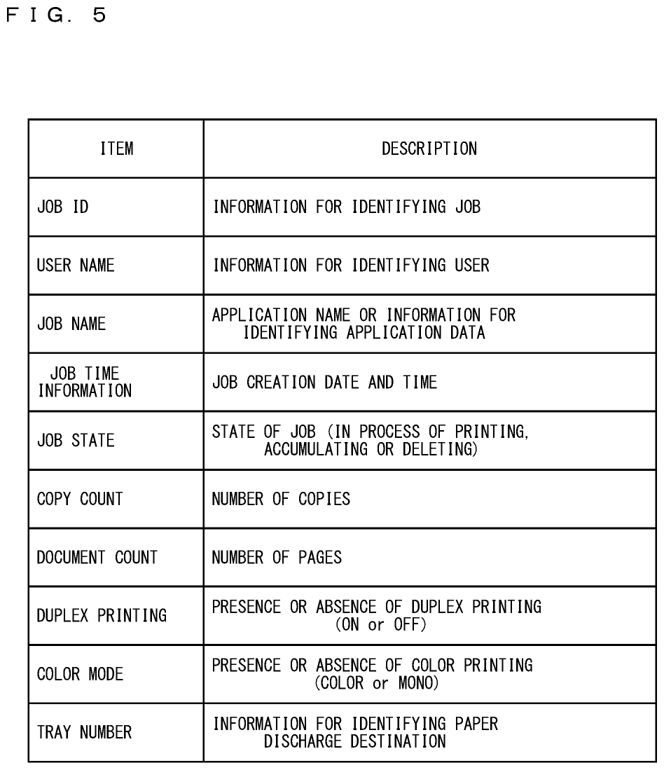

FIG. 5 is a diagram showing one example of the format of job information. Referring to FIG. 5, job information includes an item for a job ID, an item for a user name, an item for a job name, an item for a job time, an item for a job state, an item for a copy count, an item for a document count, an item for duplex printing, an item for a color mode item and an item for a tray number. Part of the printing condition is set in the item for a copy count, the item for a document count, the item for duplex printing, the item for a color mode and the item for a tray number.

In the item for a job ID, job identification information for identifying a print job is set. In the item for a user name, user identification information for identifying a user who has provided an instruction for printing. In the item for a job name, the name of the application portion 251 or/and data identification information for identifying application data are set. Application data is data to be processed by the application portion 251. In the item for a job time, the date and time when the application portion 251 generates a print job are set. In the item for a job state, state information representing a job state is set. State information includes a state in which a job is accumulated by the MFP 100, a state in which a job is executed by the MFP 100 and a state in which a job is deleted by the MFP 100, for example. In the item for a copy count, the number of copies to be made for image formation is shown. In the item for a document count, the number of pages included in application data is shown. In the item for duplex printing, the side of a recording medium on which an image is to be formed is defined. In the item for duplex printing, a value representing either duplex printing or simplex printing is set. In the item for a color mode, the number of colors in images to be formed is set. A value which is one of “COLOR” for representing a plurality of colors and “MONO” for representing a single color is set. In the item for a tray number, tray identification information for identifying any of a paper feed tray included in the paper feed unit 150 of the MFP 100 is set.

Returning to FIG. 4, the execution instructing portion 265 outputs an execution instruction to the application portion 251. An execution instruction is an instruction for the application portion 251 and is for instructing the application portion 251 to generate a print job and output the generated print job in response to a print start instruction input by the user operating the PC 200. A print job may include a printing condition, which the user operating the PC 200 inputs to the application portion 251. The printer driver portion 255 may be called by the application portion 251, and a printing condition may be input to the printer driver portion 255 by the user. Therefore, a printing condition is set in each of the application portion 251 and the printer driver portion 255.

A default setting is defined for a printing condition in each of the application portion 251 and the printer driver portion 255. In a case in which a printing condition is input by the user, a value is different from a value set in the default setting. A printing condition input by the user is defined by a value defined in the default setting for each of the application portion 251 and the printer driver portion 255 in a case in which a default value is not changed by the user, and is defined by a value to which the default value is changed by the user in a case in which the default value is changed by the user.

In response to receiving an execution instruction from the support portion 253, the application portion 251 outputs a print job to the printer driver portion 255. When receiving a print job from the application portion 251, the printer driver portion 255 changes part of the print job and transmits the changed print job to the MFP 100. Specifically, the printer driver portion 255 changes a printing condition such that a print job output from the application portion 251 is set to be accumulated without being executed. The printer driver portion 255 controls the communication unit 205 to transmit a print job after a printing condition is changed to the MFP 100. In a case in which the communication I/F unit 112 receives a print job, the MFP 100 stores the print job in the HDD 115 without executing the print job in accordance with a printing condition set in the print job.

After an execution instruction is output by the execution instructing portion 265, the job information acquiring portion 267 acquires job information relating to a print job stored in the MFP 100. Specifically, the job information acquiring portion 267 controls the communication unit 205 to communicate with the MFP 100 and acquires job information from the MFP 100. For example, the job information acquiring portion 267 acquires job information from the MFP 100 by communicating with the MFP 100 using a communication method defined by the IPP (Internet Printing Protocol) standard. Further, the job information acquiring portion 267 may acquire job information from the MFP 100 by communicating with the MFP 100 using PJL (Printer Job Language). Further, the job information acquiring portion 267 may communicate with the MFP 100, request the MFP 100 to transmit an MIB (Management Information Base) and acquire job information from the MIB received from the MFP 100.

The deleting portion 271 deletes a print job from the MFP 100 in response to acquisition of job information by the job information acquiring portion 267. Specifically, the deleting portion 271 controls the communication unit 205 to communicate with the MFP 100 and cause the MFP 100 to delete the print job. For example, the deleting portion 271 transmits a deletion command to the MFP 100. A deletion command includes job identification information for identifying a print job. Thus, a print job stored in the HDD 115 is deleted in the MFP 100.

The printing condition determining portion 269 determines a printing condition based on job information acquired from the MFP 100. The printing condition determining portion 269 determines a printing condition based on the number of pages included in job information. The number of pages is a value set in the item for a document count of job information. Further, the printing condition determining portion 269 determines a printing condition in accordance with a predetermined default condition. A default condition includes a setting that causes images of a plurality of pages to be arranged on one recording medium. For example, suppose that a 2in1 printing condition in which images of two pages are arranged on one recording medium in a case in which the number of pages is smaller than 8 is defined as a first default condition, and a 4in1 printing condition in which images of four pages are arranged on one recording medium in a case in which the number of pages is equal to or larger than 8 is defined as a second default condition. In this case, in a case in which the number of pages defined by job information is smaller than 8, the printing condition determining portion 269 determines a condition defined by the first default condition as a printing condition. In a case in which the number of pages defined by job information is equal to or larger than 8, the printing condition determining portion 269 determines a condition defined by the second default condition as a printing condition.

Further, the default condition includes a setting that defines the side on which an image is to be formed of a recording medium. For example, suppose that a third default condition defining that images are to be formed on both sides in a case in which the number of pages is an even number, and a fourth default condition defining that images are to be formed on one side in a case in which the number of pages is an odd number, are defined as default conditions. In this case, in a case in which the number of pages defined by job information is an even number, the printing condition determining portion 269 determines the condition for both sides defined by the third default condition as a printing condition. In a case in which the number of pages defined by job information is an odd number, the printing condition determining portion 269 determines the condition for one side defined by the fourth default condition as a printing condition. Further, the default condition may include a setting that defines a printing condition for each of a plurality of pages. For example, a default condition may be a condition defining that images are to be printed by 2in1 for pages from the first page to a certain page, and images are to be formed for each page (1in1) for the subsequent pages.

Further, the printing condition determining portion 269 determines a printing condition based on data identification information (file name) for identifying application data set in the item for a job name included in job information. In a case in which data identification information includes a reserved word, a default condition that is defined for the reserved word is determined as a printing condition. A reserved word is preferably a word representing the purpose of use of a printed paper. The reserved words include words such as “draft” and “test” as words representing that a document is a trial document rather than a formal document, for example. Further, the reserved word may be a word predetermined by the user and is registered in the support portion 253 in advance. The reserved word may include a project name, a department name and a person's name.

In a case in which the number of pages is 2 with respect to the reserved word “draft,” a printing condition defining that images are to be formed on both sides of a recording medium is used as a default condition as one example. Further, in a case in which the number of pages is 3 or 4 with respect to the reserved word “draft,” a printing condition defining formation of images on both sides of a recording medium and 2in1 is set. Further, in a case in which the number of pages is equal to or larger than 5 with respect to the reserved word “draft,” a printing condition defining formation of images on both sides of a recording medium and 4in1 is set.

In response to receiving a printing condition determined by the printing condition determining portion 269, the setting portion 273 performs setting such that a print job is executed without being accumulated and a print job is executed by the MFP 100 in accordance with the printing condition determined by the printing condition determining portion 269. The setting portion 273 provides an instruction to the printer driver portion 255 such that a print job is executed without being accumulated by the MFP 100. For example, the setting portion 273 outputs an accumulation cancel command for making a setting that causes a print job to be executed without being accumulated by the MFP 100. An accumulation cancel command includes device identification information for identifying the MFP 100. Further, the setting portion 273 outputs a setting command for making a setting that causes a print job to be executed in the MFP 100 in accordance with a printing condition determined by the printing condition determining portion 269 to the printer driver portion 255. A setting command includes a printing condition determined by the printing condition determining portion 269 and device identification information for identifying the MFP 100. After transmitting a setting command to the MFP 100, the setting portion 273 outputs a re-output instruction to the re-output instructing portion 275.

In response to receiving an accumulation cancel command from the setting portion 273, the printer driver portion 255 sets a printing condition of a print job subsequently output from the application portion 251 such that a print job is executed without being accumulated. Further, in response to receiving a setting command from the setting portion 273, the printer driver portion 255 changes a printing condition of a print job subsequently output from the application portion 251 to a value defined by a printing condition included in the setting command.

In response to receiving a re-output instruction, the re-output instructing portion 275 outputs the re-output instruction to the application portion 251. A re-output instruction is an instruction for the application portion 251 and is an instruction for re-outputting the same print job as a print job output by the application portion 251 in accordance with an execution instruction received from the execution instructing portion 265.

In response to receiving a re-output instruction from the re-output instructing portion 275, the application portion 251 outputs a print job to the printer driver portion 255. When a print job is received from the application portion 251, the printer driver portion 255 changes a printing condition set in the print job to a printing condition received from the printing condition determining portion 269 and transmits the print job in which the changed printing condition is set to the MFP 100. Specifically, the printer driver portion 255 controls the communication unit 205 to transmit the print job having the changed printing condition to the MFP 100. When the communication I/F unit 112 receives a print job, the MFP 100 executes the print job because the setting is made such that a print job is executed without being accumulated.

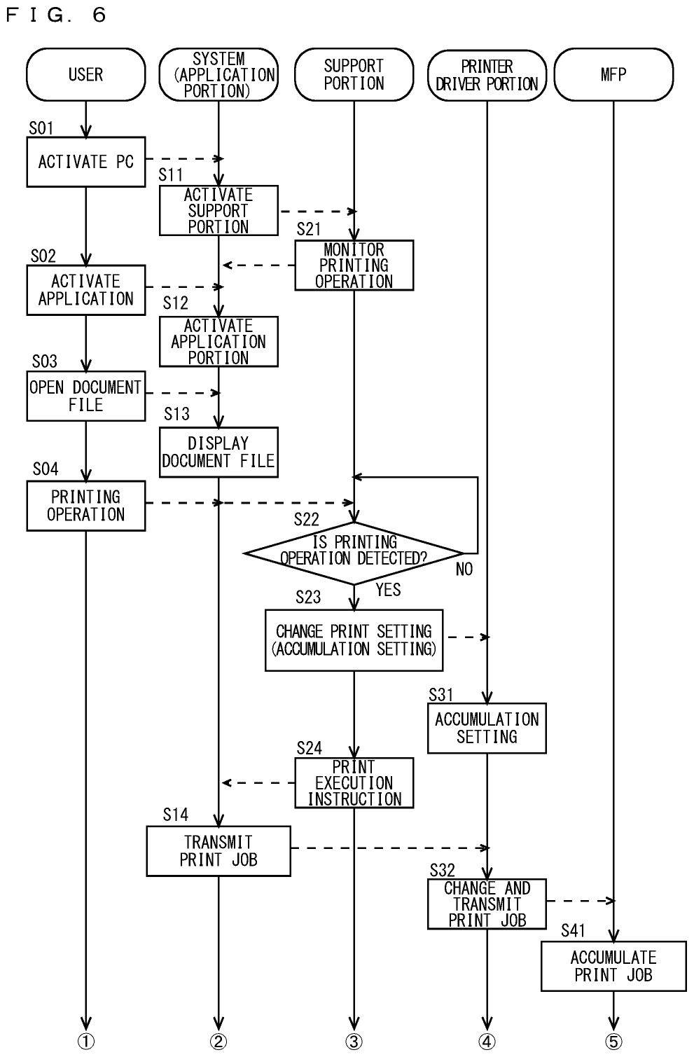

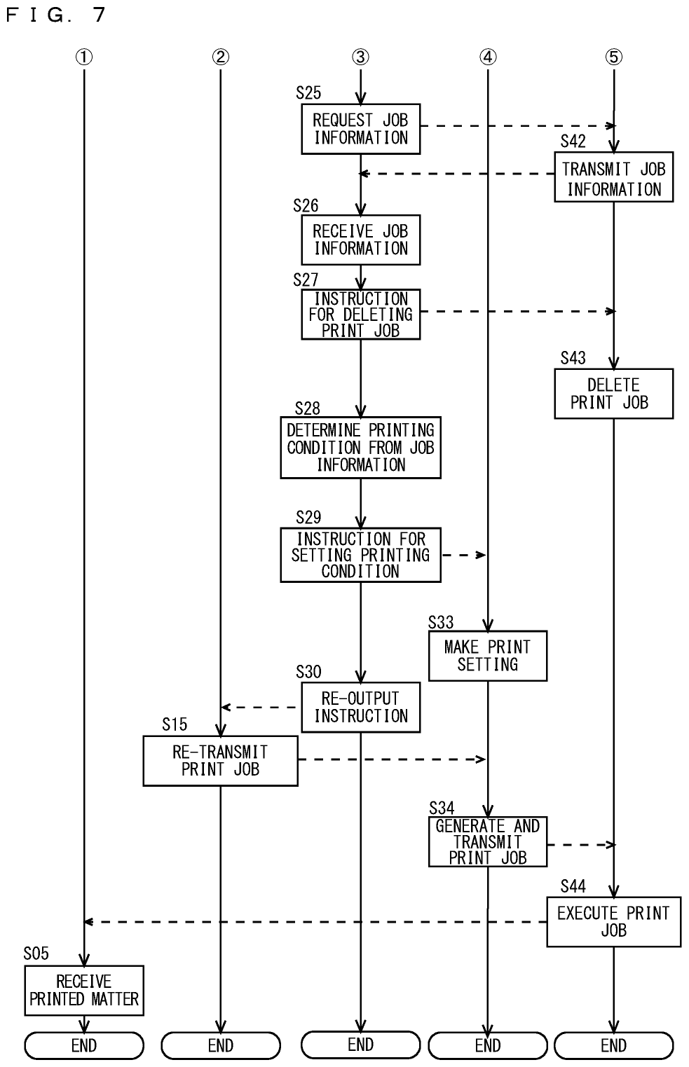

FIGS. 6 and 7 are flowcharts showing one example of a flow of a process for each of the user, the application portion, the support portion, the printer driver portion and the MFP. The process for the application portion shown in FIGS. 6 and 7 is a process to be executed by the CPU 201 when the CPU 201 executes the application program. The process for the support portion 253 shown in FIGS. 6 and 7 is a process to be executed by the CPU 201 when the CPU 201 executes the printing support program. The process for the printer driver portion 255 shown in FIGS. 6 and 7 is a process to be executed by the CPU 201 when the CPU 201 executes the printer driver program corresponding to the MFP 100.

Referring to FIGS. 6 and 7, when the user activates the PC 200 (step S01), the operating system of the PC 200 is activated (step S11), and the support portion 253 is activated by the operating system.

When activated by the operating system, the support portion 253 starts monitoring a printing operation input by the user (step S21). Here, the support portion 253 detects a printing operation input by the user by monitoring a predetermined storage area managed by the operating system. The support portion 253 determines whether a printing operation is detected (step S22). The support portion 253 waits until a printing operation is detected (NO in the step S22). If a printing operation is detected (YES in the step S22), the process proceeds to the step S23.

When the user activates the application (step S02), the application portion 251 is activated on the operating system (step S12). Then, when the user opens a document (step S03), the application portion 251 displays a document file in the display unit 206 (step S13).

Next, when the user inputs a printing operation to the PC 200 (step S04), the operating system rewrites a value in the predetermined storage area. When the support portion 253 monitoring a printing operation detects a printing operation (YES in the step S22), the process proceeds to the step S23. In the step S23, a print setting is changed to an accumulation setting. Specifically, an accumulation command for making a setting that causes a print job to be accumulated without being executed by the MFP 100 is output to the printer driver portion 255. The printer driver portion 255 that receives the accumulation command performs accumulation setting such that a print job is accumulated without being executed (step S31). Thus, the printer driver portion 255 changes a printing condition in a print job to be subsequently received from the application portion 251 such that the print job is accumulated without being executed, and performs setting such that the changed print job is transmitted to the MFP 100.

After transmitting the accumulation command, the support portion 253 outputs a print execution instruction to the application portion 251 (step S24). The application portion 251 generates a print job in accordance with the print execution instruction and transmits the print job to the printer driver portion 255 (step S14).

When receiving the print job, the printer driver portion 255 changes the print job in accordance with the accumulation setting made in the step S31 and transmits the changed print job to MFP 100 (step S32). The setting for the print job is changed to a setting that causes a print job to be accumulated without being executed. Therefore, the MFP 100 that receives a print job accumulates the print job received from the printer driver portion 255 without executing the print job (step S41).

After outputting the print execution instruction to the application portion 251, the support portion 253 requests job information from the MFP 100 (step S25). The MFP 100 transmits the job information to the PC 200 in response to the request for the job information (step S42). The support portion 253 receives the job information transmitted from the MFP 100 (step S26), and the process proceeds to the step S27. In the step S27, the support portion 253 instructs the MFP 100 to delete the print job (step S27). Specifically, the support portion 253 controls the communication unit 205 to communicate with the MFP 100 and transmit a deletion command to the MFP 100. The deletion command includes job identification information for identifying the print job. Thus, in the MFP 100, the print job stored in the HDD 115 in the step S41 is deleted (step S43).

Next, the support portion 253 determines a print setting from the job information (step S28). A printing condition is determined based on the number of pages included in the job information. For example, the number of pages to be formed on a recording medium is determined in accordance with the number of pages. Further, the printing condition may be determined in accordance with a predetermined default condition. The default condition may include a setting that causes images of a plurality of pages to be arranged on one recording medium. Further, the default condition may include a setting that defines the side on which an image is to be formed of a recording medium. Further, the printing condition may be determined based on data identification information (a file name) for identifying application data set in the item for a job name included in the job information. In a case in which the data identification information includes a reserved word, a default condition defined with respect to the reserved word is determined as a printing condition.

The support portion 253 provides an instruction for setting the determined printing condition (step S29). Specifically, the instruction is provided to the printer driver portion 255 such that a print job is executed without being accumulated and the print job is executed by the MFP 100 in accordance with the printing condition determined in the step S28. For example, an accumulation cancel command for making a setting that causes a print job to be executed without being accumulated by the MFP 100 is output to the printer driver portion 255. Further, a setting command for making a setting that causes a print job to be executed in the MFP 100 in accordance with the printing condition is output to the printer driver portion 255. The setting command includes a printing condition and device identification information for identifying the MFP 100. In response to receiving the accumulation cancel command and the setting command, the printer driver portion 255 changes a printing condition for a print job to be subsequently input (step S33).

After outputting a setting instruction, the support portion 253 provides an instruction for re-outputting to the application portion 251 (step S30). Specifically, a re-output instruction is output to the application portion 251. The re-output instruction is an instruction for re-outputting a print job. The application portion 251 that receives the re-output instruction outputs a print job to the printer driver portion 255 (step S34). The printer driver portion 255 that receives the print job changes a printing condition set in the print job to the printing condition set in the step S33, and transmits the print job in which the changed printing condition is set to the MFP 100 (step S34). The MFP 100 that receives the print job executes the print job without accumulating the print job (step S44). Thus, the user operating the PC 200 can receive a printed matter output by the MFP 100 that executes the print job (step S05).

### Modified Examples

While controlling the printer driver portion 255 in the present embodiment, the support portion 253 may directly control the MFP 100 that executes a print job. Specifically, in the step S23, the support portion 253 controls the MFP 100 and performs setting such that a print job is accumulated without being executed (step S23). Further, in the step S29, the support portion 253 controls MFP 100 to perform setting such that a print job is executed without being accumulated and perform setting such that a printing condition for a print job externally received is changed to the printing condition determined in the step S28.

As described above, the PC 200 in the present embodiment functions as the printing support device by execution of the printing support program by the CPU 111. The PC 200 detects a print start instruction input by the user, performs setting such that a print job is accumulated without being executed by the MFP 100 in response to detection of the start instruction, acquires job information relating to the print job accumulated in the MFP 100 and deletes the print job accumulated in the MFP 100. Therefore, it is possible to prevent a print job having a printing condition set by the user from being executed in MFP 100. Further, because the PC 200 determines a printing condition based on job information, printing can be performed in accordance with a printing condition corresponding to the purpose of use of a printed matter. Further, after a print job is set to be executed without being accumulated and then the job is set to be executed by the MFP 100 in accordance with a printing condition determined based on job information, the print job is re-output by a task for executing an application program. Therefore, a printing condition can be determined regardless of the type of an application program. Therefore, a user's error in setting a printing condition is reduced.

Further, the PC 200 instructs the printer driver to accumulate a print job without execution by the MFP 100, and instructs the printer driver to change the print job in accordance with a printing condition. Therefore, because the printer driver is controlled, it is not necessary to control the MFP 100. Therefore, it is possible to reduce an error in setting a printing condition regardless of the type of the MFP 100.

Further, the PC 200 determines a printing condition based on the number of pages included in job information. Therefore, a printing condition can differ depending on the number of pages included in a print job.

Further, the PC 200 also determines a printing condition based on job identification information for identifying a print job included in job information. Therefore, because the purpose of use of a printed matter can be acquired from job identification information, it is possible to determine a printing condition in accordance with the purpose of use.

Further, the PC 200 also determines a printing condition in accordance with a predetermined default condition. Therefore, because prescribed conditions respectively corresponding to a plurality of purposes of use are defined, a printing condition can be easily determined.

Further, the default condition includes a setting that causes images of a plurality of pages to be arranged on one recording medium. Therefore, the number of pages to be arranged on one recording medium can differ depending on the purpose of use.

Further, the default condition includes a setting that defines the side on which an image is formed of a recording medium. Therefore, the side of a recording medium on which an image is to be formed can differ depending on the purpose of use.

Further, the default condition includes a setting that defines a printing condition for each of a plurality of pages. Therefore, the printing condition can differ for each page.

Although embodiments of the present invention have been described and illustrated in detail, the disclosed embodiments are made for purpose of illustration and example only and not limitation. The scope of the present invention should be interpreted by terms of the appended claims.

What is claimed is:

1. A printing support device that supports a printing process of causing an image processing apparatus to execute a print job, comprising a hardware processor,
the hardware processor
detecting a print start instruction;
performing setting such that the print job is accumulated without being executed by the image forming apparatus in response to detection of the start instruction;
acquiring job information in regard to the print job accumulated in the image forming apparatus;
determining a printing condition based on the job information;
performing setting such that the print job is executed by the image forming apparatus in accordance with the determined printing condition after the printing condition is determined; and
instructing the application to output the print job.

2. The printing support device according to claim 1, wherein
the hardware processor
provides an instruction to a printer driver controlling the image forming apparatus such that the print job is accumulated without being executed by the image forming apparatus, and
instructs the printer driver to change the print job in accordance with the printing condition.

3. The printing support device according to claim 1, wherein
the hardware processor determines the printing condition based on a page count included in the job information.

4. The printing support device according to claim 3, wherein
the hardware processor determines the printing condition in accordance with a predetermined default condition.

5. The printing support device according to claim 4, wherein
the default condition includes a setting that causes images of a plurality of pages to be arranged in one recording medium.

6. The printing support device according to claim 4, wherein
the default condition includes a setting that defines a side on which an image is to be formed of a recording medium.

7. The printing support device according to claim 4, wherein
the default condition includes a setting that defines a printing condition for each of a plurality of pages.

8. The printing support device according to claim 1, wherein
the hardware processor determines the printing condition based on job identification information for identifying the print job included in the job information.

9. A printing support method that is performed in a printing support device that executes a printing process of causing an image processing apparatus to execute a print job, including:
an instruction detecting step of detecting a print start instruction;
an accumulation setting step of performing setting such that the print job is accumulated without being executed by the image forming apparatus in response to detection of the start instruction;
a job information acquiring step of acquiring job information in regard to the print job accumulated in the image forming apparatus;
a printing condition determining step of determining a printing condition based on the job information;
a setting step of performing setting such that the print job is executed by the image forming apparatus in accordance with the determined printing condition after the printing condition is determined; and
an output instructing step of instructing the application to output the print job.

10. The printing support method according to claim 9, wherein
the accumulation setting step includes providing an instruction to a printer driver controlling the image forming apparatus such that the print job is accumulated without being executed by the image forming apparatus, and
the setting step includes instructing the printer driver to change the print job in accordance with the printing condition.

11. The printing support method according to claim 9, wherein
the printing condition determining step includes determining the printing condition based on a page count included in the job information.

12. The printing support method according to claim 11, wherein
the printing condition determining step includes determining the printing condition in accordance with a predetermined default condition.

13. The printing support method according to claim 12, wherein
the default condition includes a setting that causes images of a plurality of pages to be arranged in one recording medium.

14. The printing support method according to claim 12, wherein
the default condition includes a setting that defines a side on which an image is to be formed of a recording medium.

15. The printing support method according to claim 12, wherein
the default condition includes a setting that defines a printing condition for each of a plurality of pages.

16. The printing support method according to claim 1, wherein
the setting determining step includes determining the printing condition based on job identification information for identifying the print job included in the job information.

17. A non-transitory computer-readable recording medium encoded with a printing support program executed in a computer that executes a printing process of causing an image processing apparatus to execute a print job, causing the computer to perform:
an instruction detecting step of detecting a print start instruction;
an accumulation setting step of performing setting such that the print job is accumulated without being executed by the image forming apparatus in response to detection of the start instruction;
a job information acquiring step of acquiring job information in regard to the print job accumulated in the image forming apparatus;
a printing condition determining step of determining a printing condition based on the job information;
a setting step of performing setting such that the print job is executed by the image forming apparatus in accordance with the determined printing condition after the printing condition is determined; and
an output instructing step of instructing the application to output the print job.
